(19) United States
(12) Patent Application Publication
(10) Pub. No.: US 2006/0210448 A1
(43) Pub. Date: Sep. 21, 2006

(54) Fecal specimen collection, preserving and transport device and method

(76) Inventors: Naishu Wang, San Diego, CA (US); David F. Zhou, San Diego, CA (US)

Correspondence Address: CHARMASSON, BUCHACA & LEACH, LLP, 1545 HOTEL CIRCLE SOUTH, SUITE 150, SAN DIEGO, CA, 92108-3426, US

(21) Appl. No.: 11/078,876

(22) Filed: Mar. 10, 2005

(51) Int. Cl. B01L 3/00

(52) U.S. Cl. 422/102

(57) ABSTRACT

A device for quantitively collecting, preserving, storing and mailing a fresh and wet specimen of fecal or other biological matter for later analysis comprises a simple tubular vessel double sealed at one end by a machine manipulable plug having breakable hollow nib and cover, and that is engaged at the opposite end by a machine manipulable stopper from which a specimen carrying stick axially projects into the vessel through an internal sealable septum spanning a median section of the vessel. The cross-sectional profile of the stick is shaped to form a widened shoulder carrying a resilient washer. The shoulder matingly engages a correspondingly shaped passageway in the septum when the stopper engages the vessel which restricts the amount of specimen passing therethrough. The amount of specimen and preserving fluid are quantitatively balanced and remain so until part or all of the fluid is extracted for analysis either manually by breaking of the sealing nib or automatedly by machine removal of the plug or stopper. Collection by a patient or unskilled person is enhanced by providing the tubular vessel as part of a sample collection and return kit which further contains a disposable paper catch web which is made to be temporarily secured to a toilet droopingly spanning the seat to catch the feces for sampling. The kit also provides a sealable plastic bag and a crush resistant mailing carton. The above components of the kit are carried within a sterile bag until used.

### FIELD OF THE INVENTION

This invention relates to methods and devices practiced and used in the collection, preservation, transportation and analysis of fluid, viscous or particulate solid or otherwise flowable or sequacious material samples of chemical, biological or environmental material including tissues, bodies, food, and soil, and more specifically to instruments used for specimens of fecal matter for screening the gastrointestinal tract for bleeding and colorectal cancer, or other similar biological materials.

### BACKGROUND OF THE INVENTION

Several devices and methods have been used in the past to collect, preserve, transport and dispense chemical, environmental or biomedical specimens including fecal samples for later analysis by a laboratory or for clinical studies. The most common Guaiac Dye Test has been a dried smear paper pad, upon which, in the case of fecal samples, three consecutive specimens are smeared with dietary restrictions, covered, then sent for analysis. One of the most common problems associated with this hundred years old device and method is dehydration. Even under rehydrating conditions, a fecal occult blood test of dry samples on paper pads will give a high rate of false positive or negative results. A false positive result may trigger a relatively expensive colonoscopic or barium enema examination that will probably or eventually eliminate the false diagnosis. In the case of a false negative result, an early stage colorectal cancer may be missed, and if metastasis then occurs, the cancer may become incurable.

Another fecal sample collection device of the prior art comprises a simple cylindrical tube with a cap having a breakable tip and a plastic stick connected to the inside of the screw cap. The tube contains a certain amount of extraction buffer. The stick is inserted into fresh feces several times then put back into the tube and the cap is tightly secured to seal the tube. The main advantage of this procedure is that the extraction buffer keeps the fresh specimen wet and a preserving reagent mixed therewith may slow down the degradation of the biological molecule or its markers. While this method constitutes a substantial improvement over the smear paper devices of the past, unintended breakdown of the tip on top of the cap has occurred during manipulation or mailing of the specimen resulting in leakage and possible contamination. Moreover, specimens have a tendency to include excessive amounts of fecal material for the fixed amount of preservative or reagent contained in the tube resulting in false positive analysis. Another improved device of the prior art is disclosed in U.S. Pat. No. 6,063,038 Diamond et al. In this case, a filtering membrane is provided between the body of the shipping vessel which holds the specimen and a preserving/reagent solution and the hollowed inside of the stick itself which can be accessed through a self-sealing membrane to extract a part of the liquid containing only the amount of specimen that passed through the filtering membrane. This improved device still suffers from a high risk of spillage of the preservative/reagent and a lack of quantitative mixing of the sample and preserving/reagent fluid.

Other devices provide for the dry storage of fecal material as disclosed in Kozak et al. U.S. Pat. No. 6,299,842 for purposes such as occult blood assays that detect labile exoantegens, but are not suited to carrying non-dry samples.

Due to the high cost of skilled labor used to manually manipulate and perform tests on the samples, devices which encourage greater automation and automation efficiency are generally preferred.

Because of the private and personal nature of fecal specimen collecting, collection is often performed by the relatively untrained donor. Further, because of the distasteful nature of feces, donors often have difficulty properly collecting or otherwise handling the fecal material. There is a need, therefore, for a device which reduces the handling of feces and the potential for close contact.

For feces which have a less cohesive consistency, deposit into toilet can cause dispersal making specimen collection difficult if not impossible.

Analysis often occurs at a remote site requiring significant transport and handling, often through the mail. Transport through the mail often involves rough handling. Therefore, the containing device should be resistant to rupture or leakage. U.S. Pat. No. 6,780,160 discloses a dual ended, dual sealed device. It has been found that the septum seal is still prone to leakage when subjected to radially impinging crushing forces.

The instant invention results from some attempt to provide a practical solution to the problems and disadvantages of the aforesaid devices of the prior art.

### SUMMARY OF THE INVENTION

The principal and secondary objects of this invention are to provide an improved specimen collection, preserving and transport device and method.

These and other valuable objects are achieved by providing a simple tubular vessel double sealed at one end by a machine manipulable plug having breakable hollow nib and cover, and that is engaged at the opposite end by a machine manipulable stopper from which a stick axially projects into the vessel through an internal sealable septum spanning a median section of the vessel. A sample-holding portion on the stick passes through a passageway through the center of the septum. The cross-sectional profile of the stick is further shaped to form a widened medial shoulder portion carrying a resilient washer. The shoulder is axially located on the stick so that it matingly engages the correspondingly bowl-shaped passageway when the stopper engages the vessel. Below a bowl-shaped portion, the passageway has a constriction which closely matches cross-section of the specimen-holding portion of the stick so that excess specimen is conveniently prevented from passing into the most distal chamber of the vessel that contains a preserving fluid. The amount of specimen and preserving fluid are quantitatively balanced and remain so until part or all of the fluid is extracted for manual analysis after breaking of the sealing nib or for automated analysis after a machine removes the plug.

Collection by a patient or unskilled person is enhanced by providing the tubular vessel as part of a sampling kit which further contains a disposable paper catch web which is made to be temporarily secured to a toilet droopingly spanning the seat to catch the feces for sampling. The kit also provides a sealable plastic bag and a crush resistant mailing carton. The above components of the kit are carried within a sterile bag until used.

### BRIEF DESCRIPTION OF THE DRAWING

FIG. 1 is a cross-sectional side view of a biological specimen-collecting, preserving, storage, transport, and analysis device according to the invention.

FIG. 2 is a partial cross-sectional enlarged side view of the stopper and second chamber of the device FIG. 1.

FIG. 3 is a partial cross-sectional enlarged side view of the septum portion of the device FIG. 1.

FIG. 4 is a cross-sectional end view of the end portion plug of the device FIG. 1 taken along line 4-4.

FIG. 5 is a plan end view of the knob of the stopper of the device FIG. 1.

FIG. 6 is a diagrammatic perspective view of the kit components according to the invention.

FIG. 7 is a diagrammatic perspective view of the web installed on a toilet.

FIG. 8 is a partial cross-sectional side view of the web portion of the kit of FIG. 6 installed on a toilet seat of FIG. 7 taken along line 8-8.

FIG. 9 is a diagrammatic cross-sectional side view of a plurality of vessels according to the invention loaded in an automated testing carriage.

### DESCRIPTION OF THE PREFERRED EMBODIMENT OF THE INVENTION

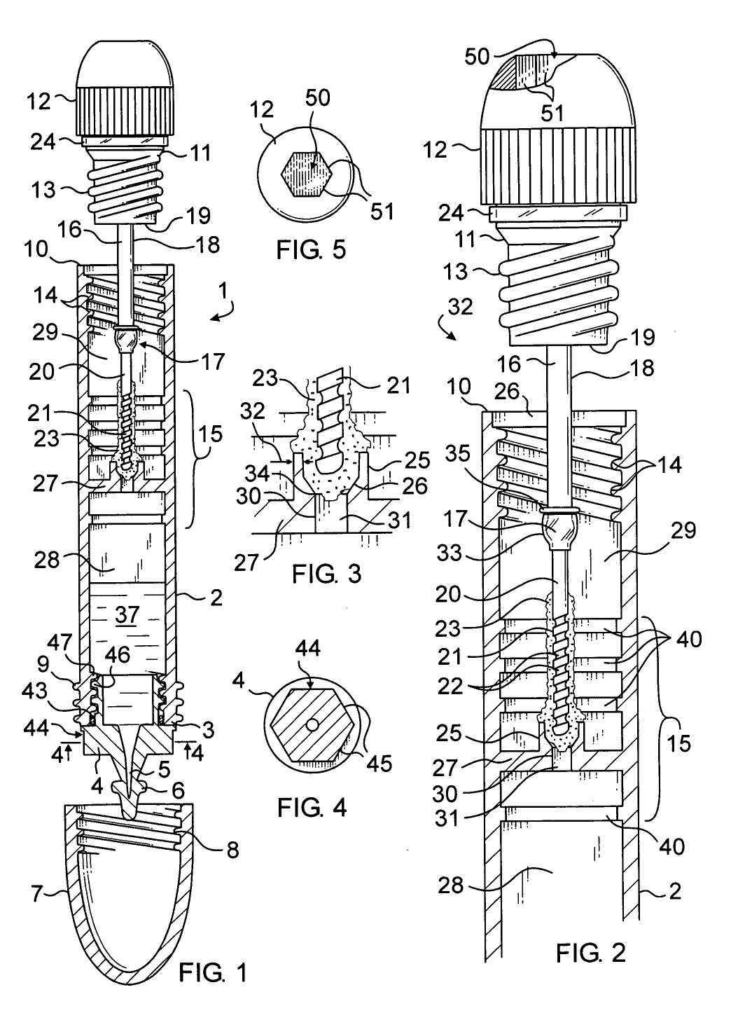

Referring now to the drawing, there is shown in FIGS. 1-5 a device 1 specially adapted to collect a specimen of fecal or other chemical or biological matter, store and preserve it while it is mailed or otherwise transported to a laboratory for either manual or machine analysis or both. The device comprises a tubular, preferably cylindrical, vessel 2 having a first end 3 closed by an end portion plug 4 and defining an access port 5 which is releasably sealed by a hollow nib 6 that can be easily broken to open the access port and allow convenient, eyedropper-type dispensing. A cover 7 shaped and dimensioned to enclose the plug 4 and breakable nib 6 has a threaded inner wall section 8 that cooperates with a correspondingly threaded area 9 on the outer wall of the vessel to secure the cover and thus, protect the breakable nib 6.

Preferably, the end portion plug 4 that mounts the breakable nib 6 at the first end 3 of the vessel is not molded integrally with the wall of the vessel, but rather is removable and is installed only after the first chamber 28 has been filled with the preserving fluid 37. The plug can be bonded to the vessel to seal against fluid leaks. Such bonding can be permanent through use of an adhesive for example, or semi-permanent by dimensioning the plug to create a pressure seal for example. More preferably, the plug is formed to be machine removable as described below.

Referring now to FIGS. 2 and 4, the end portion plug 4 is adapted to be readily secured and removed in an automated fashion by having a machine manipulable angularly keyed outer surface 44 facilitating the application of torque to the plug. In this embodiment the angularly keyed surface is formed by a plurality of facets 45 similar to the radial outer surface of a standard nut fastener. The plug is further formed to have an outer male threaded portion 46 on the end opposite the breakable nib 6. The threaded portion of the plug releasably engages a corresponding inner female threaded portion 47 in the vessel 2 proximate to the first end 3. In this way, automated machinery can remove and replace the plug. To further encourage automated engagement of the facets, the surface of each facet may be angled inwardly toward the nib end of the plug. A resilient circumferential O-ring 43 provides for greater sealing against fluid leaks.

Referring now to FIGS. 1-3, the opposite, normally open, end 10 of the vessel is engaged by a stopper 11 comprising a knob 12 and a threaded plunger 13. A sealing ring 24 is carried on the proximal or upper end of the plunger sized to seal against a bearing structure 26 when the stopper is fully engaged in the vessel. Screw threads 14 matingly cooperating with the threaded plunger are provided along the inside wall of the vessel from the second end 10 down toward a median portion 15 of the vessel. A stick 18 projects axially from the stopper, more specifically, from the distal end 19 of the plunger into the vessel. The stick comprises a proximal shaft portion 16 leading toward a medial shoulder portion 17 from which extends a substantially cylindrical shank 20 and a sample-holding distal portion 21 which generally consists of an oblong cylindrical member into which indentations 22 in the form of an helicoidal groove have been cut for carrying an amount of fecal material 23. The radius of the distal portion is substantially the same as the radius of the cylindrical shank 20.

A transversal septum 27 in the median portion 15 of the vessel divides the vessel into a first chamber 28 sealed by the closed end 3 and a second chamber 29 accessible through the second end 10. A passageway 30 through the middle of the septum and axially lined up with the stick 18 has a narrowed channel section formed into a substantially cylindrical aperture 31 with a diameter commensurate with that of the shank 20, that is a radius substantially equal to the radius of the shank 20 and sample-holding portion 21. The presence of the shank in this narrowed aperture acts to seal passageway between the two chambers 28,29.

It should be noted that this bonding of the end portion plug 4 and the cover 7 that further occludes both the access port 5 controlled by the breakable nib and the seal between the plug and the vessel wall, combined with the double seal provided by the shank 20 of the stick closing the passageway 30 and the stopper 11 closing the second end 10 of the vessel assures against any leakage of the preserving fluid during shipment, before and after collection of the specimen.

When the knob 12 of the stopper is turned clockwise, the sample-holding portion 21 of the stick 18 progressively translates from the second chamber 29 into the first chamber 28 through the passageway constituted by the aperture 31 until such time as shoulder 17 engages and seals the aperture. This also acts to scrape away excess fecal mater so that only a quantitatively selected amount of matter carried in the indentations enters the first chamber. Excess fecal matter may also be held in the first chamber to dry for later optional analysis.

As shown most clearly in FIG. 3, in order to provide a more rigorous seal of the passageway, the middle of the septum is formed to have a pedestal 25 extending upward into the second chamber 29, and the passageway shaped to form a central hollow bowl 26. The bowl's radial dimension decreases in the axially distal or downward direction toward the first chamber 28 until it is the radius of the generally cylindrical constriction aperture 31 at its distal terminus 34. The cross-sectional geometry of the bowl is substantially symmetrical with the cross-sectional geometry of the shoulder 17 of the stick which carries a washer 33 made from resilient flexible material such as soft plastic or rubber. The washer is held in place by its own resiliency and forms a generally tapering outer surface which can be for example conically shaped or bell-shaped. A circumferential haft 35 formed onto the stick adjacent to the proximal or upper edge of the shoulder prevents upward or proximal migration of the washer. The cooperatively shaped washer as mounted upon the shoulder 13 of the stick and the passageway of the septum 17 provide a positive seal over a larger range of plunger positions and offer resistance to leakage caused by crushing forces upon the device, especially radial crushing forces at the median portion 15 of the vessel. Alternately, or in addition to the above features, at its upper periphery the pedestal has a radial thickness 32 selected to provide a slight flexibility to form a more positive seal when engaged by the shoulder portion of the stick. The presence of the washered shoulder in this bowl acts to further resiliently seal the passageway between the two chambers 28,29.

As shown most clearly in FIG. 2, to prevent crush related leakage of the septum seal without unduly increasing the amount of material and hence weight or manufacturing expense of the vessel, the vessel wall is formed to have a number of stiffening ribs 40 extending from the inner wall of the vessel near the septum 27. The ribs are preferably shaped to be circumferential rings each oriented to lie substantially within a plane perpendicular to the major axis of the vessel and have a given axial length and radial width, and are axially located in the median section 15 of the vessel and are axially spaced apart from each other and the septum 27. Although ribbing structures could be formed into the outside wall of the vessel, this is not preferred because they could be a source for fouling or jamming during the automated manipulation of the device. The outer surface of the wall of the vessel is therefore kept smooth.

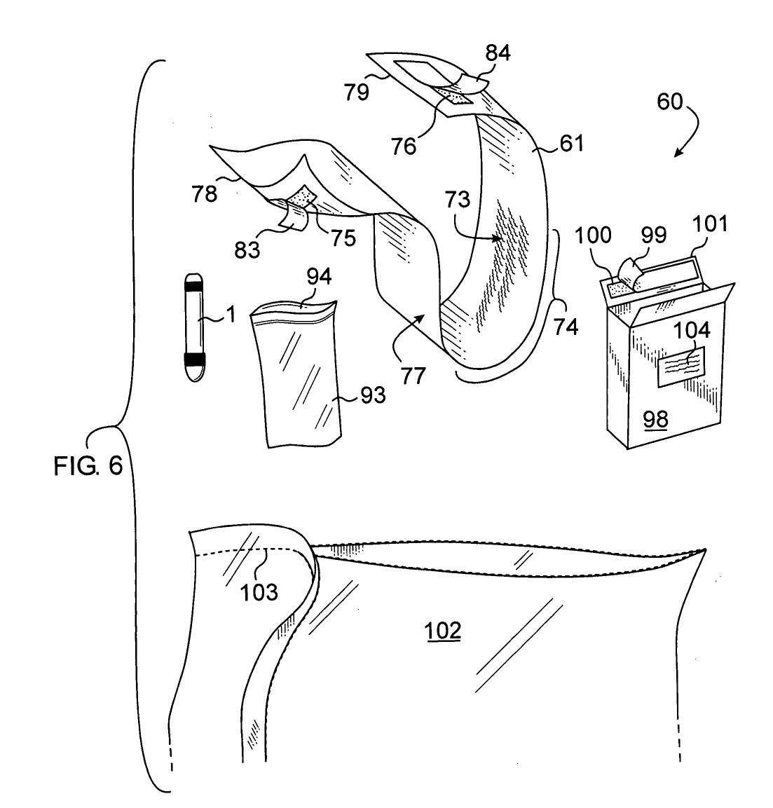

Referring now to FIGS. 2 and 5, the stopper 11 is similarly adapted to be readily secured and removed in an automated fashion by having a machine manipulable angularly keyed recess 50 formed into the top end of the knob 12 portion facilitating the application of torque to the stopper. In this embodiment the angularly keyed surface is formed by a plurality of facets 51 similar to the radial inner surface of a standard hex key head fastener. In this way, automated machinery can remove and replace the stopper. Further, the recess 50 can be used as a means to support and affix the device upon a correspondingly sized and shaped prong extending from a carrier for automated analysis. The carrier can be equipped with an array of such prongs for carrying an array of devices.

In this way, by providing means for both ends of the device to be double sealed and machine manipulable and accessible, the device can be used rapidly, efficiently, in large lot sizes by a number of automated machinery types which may be designed to access one or the other end, while still providing a rugged seal at the other end to maintain containment.

Referring now to FIG. 6, there is shown a kit 60 having components which include a collection, storage, mailing and analysis (“CSMA”) device 1 as described above in connection with FIGS. 1 and 2, a fecal specimen catch web 61, a sealable vessel carrying bag 93, a crush resistant mailing box 98, and sterile openable packaging pouch 102. The components of the kit come prepackaged in the pouch which opens along a top scoring line 103. Alternately, but less preferably, other collection and transport devices known to the art may be used, such as disclosed in U.S. Pat. No. 6,780,160 incorporated herein by this reference. The entire device 1 is loadable into the shipping bag 93 which has a sealable open end 94. The bag is preferably made from an inexpensive, durable, fluid-resistant plastic material. The sealed bag containing the device can be loaded into the mailing box 98 which has a pealable wax paper strip 99 covering an adhesive patch 100 formed on a flap 101 for sealing the box. The box also carries a mailing label 104 to indicate an address.

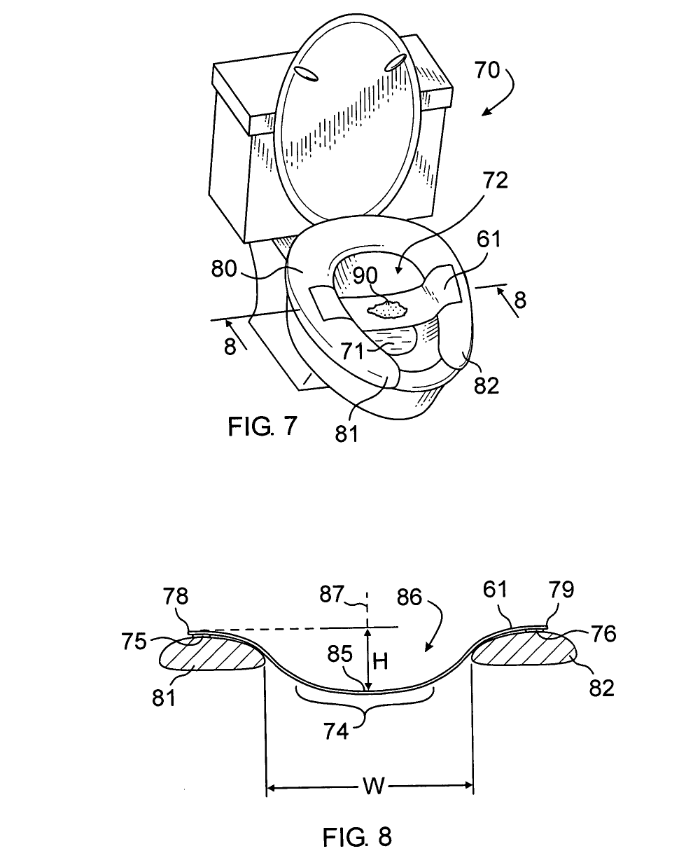

Referring now to FIGS. 6-8, the web 61 component of the kit is made to assist in the collection of fecal material by relatively unskilled persons, or persons of limited dexterity. The web allows the user to conveniently collect a fecal sample while at a toilet 70 without the specimen or the user contacting the toilet water 71. The web 61 is preferably made from a flexible, inexpensive disposable sheet material such as flushable paper or similar type material. When laid flat, the web has a generally quadrangular shape for simplicity having a medial portion 74 and opposite side edges 78,79, but may have other shapes. The web is sized to have a dimension which allows the web to span across the toilet seat opening 72 of a given maximum lateral width W which is typically between about 18 centimeters (“cm”) and about 22 cm for most common toilets. Further, the web can be made to be 180 degrees rotationally symmetrical about an axis 87 perpendicular to an upper surface so that one end of the web can connect to either arm of the seat.

As shown most clearly in FIG. 8, the dimension between the opposite ends 78,79 is selected to allow the middle part 85 of the medial portion 74 to droop down a distance H from the level of the upper surface of the seat arms 81,82 to form a pocket 86 below the user during use to make room for the fecal matter. The droop distance H has been found to most preferably be between about 4 centimeters (“cm”) and about 5 cm. The other dimensions of the web are selected so that it only partially covers the toilet opening 72 so that urine or excess fecal matter may pass on into the toilet bowl.

The web 61 is releasably attached to the toilet 70 by means of a pair of adhesive patches 75,76 formed onto the web undersurface 77 each proximate to one of the opposite ends 78,79. The adhesive patches are sized, shaped and located to contact the upper surface of each of the opposite arms 81,82 of the toilet seat 80 thereby allowing the medial portion 74 to droopingly span the toilet seat opening. The adhesive strips are protected prior to usage by wax paper strips 83,84.

Optionally, the web has an upper surface portion 73 which is treated to have an affinity for capturing fecal matter. This treatment can simply be a corrugation or other surface roughness to increase friction. The treatment may also be limited to the medial portion 74 of the web which is intended to contact the fecal matter.

The device may be used as follows. At the factory, the plunger 11 is fully or partially screwed into the second end of the vessel and the passageway 30 sealed, a measured volume of preserving liquid 37 is introduced into the first chamber through the first end 3 which is then sealed by the installation and bonding of the end portion plug 4. The volume is measured to provide the desired concentration of specimen that will eventually be found in suspension in the liquid. The device is marked about the first end 3, such as on the cover 7, with a legend such as “For Laboratory Use” or “Lab End”. The knob 12 or upper area of the vessel is marked with another legend such as “Open Here” or “Patient End”. The device along with the other components of the kit are prepackaged into the sterile pouch and distributed for use as a sample collection and return kit package.

The collection of the specimen by the patient or an assisting individual goes as follows. The sterile pouch is opened and the catch web removed. On one side of the web the protective paper is removed to expose a first adhesive patch which is then contacted with one of the lateral arms of a toilet seat. The other adhesive patch is then exposed and contacted with the opposite seat arm so that the medial portion of the web droops down through the toilet seat hole. The donor then sits on the seat and deposits an amount of fecal matter. Holding the stopper 11 by the knob 12 and after unscrewing it and separating it from the vessel, the user plunges the sample-holding portion 21 of the stick into the amount of matter on the web at least three times, more preferably over five times and most preferably while twisting the stick during the axial plunging motion. The stick, which now carries a volume of matter to be analyzed, is then inserted back into the vessel and the stopper is screwed down until the sample-holding portion passes completely through the passageway 30 of the septum. During this procedure, the walls of the constricting aperture 31 coming into intimate contact with the non-indented part of the sample-holding portion and shank, wipe out any excess material which is not held within the helicoidal groove, preventing that excess material from reaching the first chamber. Accordingly, only a quantitively metered amount of specimen matter is allowed into the first chamber. The first chamber contains the metered volume of preserving fluid 37, preferably a liquid which will remain in contact with the specimen matter throughout storage and transportation of the vessel until part or all of it is drained for analysis by breaking the nib 6 or is otherwise accessed by automated machinery through removal of the threaded plug at the closed end of the vessel or the threaded stopper at the open end.

It should be noted that the preserving liquid in the first chamber could be safely secured initially by a breakable barrier across the passageway 30 of the septum or by a resiliently self-sealing aperture. In which case, at the factory, the stopper would be loaded separately into the kit apart from the vessel, or only partially engaged into the vessel, keeping the sample-holding portion in the second chamber. Only after collection of the specimen would the stopper be completely screwed into the vessel and the sample-holding portion forced through the septum. Instead of the end portion plug 4, the first end of the vessel could be closed by a diaphragm through which a self-sealing access port can be practiced by means of a syringe or any other equivalent releasable sealing structure.

The entire device 1 is then loaded into the shipping bag 93 and the bag sealed. The sealed bag is then loaded into the crush resistant mailing box which is then sealed and mailed to the analysis lab.

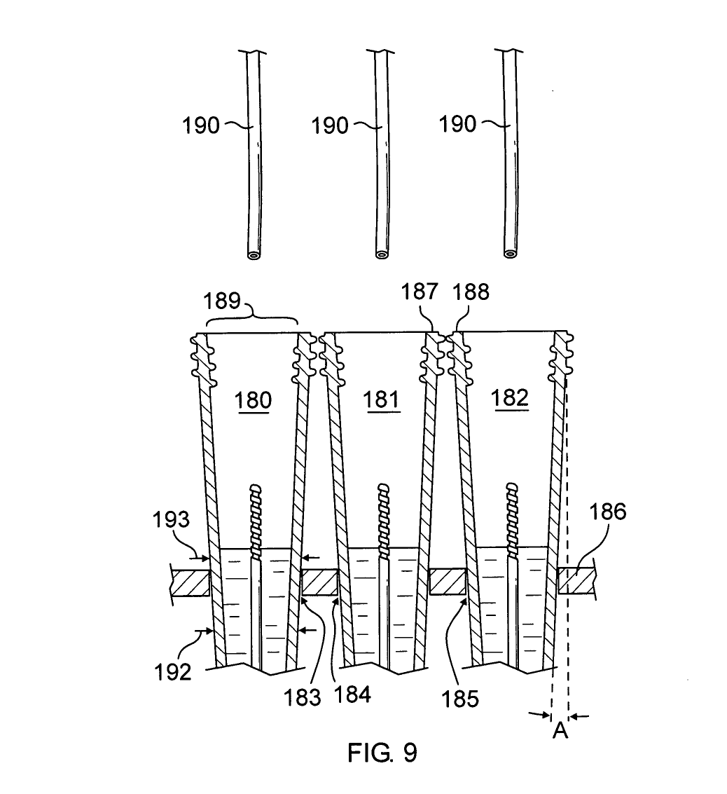

Referring now to FIG. 9, there is shown a plurality of generally cylindrical vessels 180,181,182 each as described above in connection with the device of FIG. 1. However, as shown here, each is formed to have an outer vessel wall diameter which gently tapers according to its axial location. The overall taper has been greatly exaggerated in this figure to show that the vessel can be readily inserted into a testing carriage 186. The taper allows each vessel to be inserted narrow diameter end first into a hole 183,184,185 where it sinks through the hole until the increasing outer diameter of the vessel reaches the inside diameter of the hole. The structure of the vessel can therefore be said to have an axially medial surface portion 192 having a narrower diameter or axial cross-section than an adjacent axially medial surface portion 193. In this way, the vessel is securely held in place within the carriage and can be easily placed or removed by automated machinery. Adjacent vessels are similarly held. The tapering allows a close bunching together of adjacent vessels, even allowing contact between adjacent vessels at the broad diameter end 187, 188, thereby allowing the carriage to carry an increased number of vessels. This structure also provides a wider top opening 189 allowing for greater error variation in the location of each of the flexible testing probes 190 which access the fluid within the vessel in an automated testing fashion. The angle A formed between the vertical and the tapered surface of the vessel is selected to provide close packing while accommodating existing carriers and providing adequate vessel volume. In most common applications for a linear taper, the angle A is preferably between about 0.25 and 5.0 degrees. Although the present embodiment discloses a linear taper providing a generally frusto-conical shape to the vessel, those skilled in the art will readily appreciate non-linear tapers.

In this way, this invention provides a convenient, safe and inexpensive to manufacture device and method for collection by a patient or unskilled person of fresh fecal or other biological, chemical or environmental specimens in a quantitatively metered manner and for the preservation, storage and leakproof shipping of the specimen through the mail to a laboratory for further storage and analysis through either manual or automated means while avoiding degradation of the specimen through unwanted dehydration or the imbalanced combination of specimen and preserving agents, and optionally providing for preservation of an amount of dry material. What is provided is a unique Collection, Storage, Mailing and Analysis (“CSMA”) specimen handling device.

While the preferred embodiments of the invention have been described, modifications can be made and other embodiments may be devised without departing from the spirit of the invention and the scope of the appended claims.

What is claimed is:

1. A device, for quantitatively collecting, preserving and transporting a specimen of material for: later analysis, which comprises:
a tubular vessel having a first closed end defining at least one sealed access port, a second open end opposite said first end and a transversal septum in a median portion of said vessel, said septum dividing said vessel into a first chamber sealed by said closed end and a second chamber accessible through said second end, said septum further having an axial passageway therethrough defining a given cross-sectional geometry;
a stopper shaped and dimensioned to close said open end;
a stick projecting axially from said stopper into said vessel;
said stick comprising:
a sample-holding distal portion extending through said passageway and into said first chamber when said stopper is secured upon said open end; and
a medial portion contacting said passageway having a resilient washer mounted thereon, said washer having a cross-sectional geometry substantially symmetrical with said given cross-sectional geometry, whereby said passageway is resiliently sealed by said medial portion.

2. The device of claim 1, which further comprises at least one stiffening rib formed into said vessel proximate to said septum.

3. The device of claim 2, wherein said rib comprises a circumferential ring extending radially inward from an inner wall of said vessel.

4. The device of claim 3, which further comprises a plurality of stiffening ribs formed into said vessel proximate to said septum, wherein each of said ribs are axially spaced apart.

5. The device of claim 1, wherein said sealed access port comprises an end-breakable hollow nib.

6. The device of claim 5, which further comprises:
a cover shaped and dimensioned to cap said closed end and nib;
wherein the closed end of said vessel and said cover have cooperating screw threads; and,
wherein the open end of said vessel and said stopper have cooperating screw threads.

7. The device of claim 1, which further comprises a liquid in said first chamber.

8. The device of claim 7, wherein said first chamber is doubly sealed at opposite ends.

9. The device of claim 1, wherein said sealed access port is releasably sealed by a plug, and wherein said plug is threaded to releasably engage said first closed end having cooperative threads.

10. The device of claim 9, wherein said plug comprises a first angularly keyed outer surface, thereby making said plug machine manipulable.

11. The device of claim 10, wherein said stopper comprises a second angularly keyed outer surface, thereby making said stopper machine manipulable.

12. A kit for quantitively collecting, preserving and mailing a specimen of fecal or other biological matter for later analysis, which comprises:
a specimen containing device; and,
a disposable web sized and shaped to span a toilet seat.

13. The kit of claim 12, wherein said web is further sized and shaped to droopingly span said toilet seat.

14. The kit of claim 13, wherein said web is further shaped to be 180 degrees rotationally symmetrical about an axis perpendicular to an upper surface of said web.

15. The kit of claim 12, wherein said device comprises:
a tubular vessel having a narrow channel section and first and second opposite ends;
a stopper shaped and dimensioned to close said first end; and,
a stick extending from said stopper into said vessel and through said narrow channel section;
wherein said stick comprises a distal end having indentations and being sized to closely engage said narrow channel.

16. The kit of claim 15, wherein said device further comprises:
a plug shaped and dimensioned to close said second end; and
a cover releasably capping said second end and said plug.

17. The kit of claim 16, wherein said plug comprises a first angularly keyed outer surface, thereby making said plug machine manipulable, and wherein said stopper comprises a second angularly keyed outer surface, thereby making said stopper machine manipulable.

18. The kit of claim 12, which further comprises a sealable bag shaped and dimensioned to enclose said device.

19. The kit of claim 18, which further comprises a crush resistant mailing box shaped and dimensioned to contain said bag while enclosing said device.

20. A method for quantitively collecting a specimen of biological matter which comprises:
depositing said matter onto a disposable web droopingly spanning a toilet seat;
repeatedly dipping the indented distal end of a stick into said matter;
inserting said distal end into a vessel through a passageway having an aperture shaped and dimensioned to intimately and circumferentially contact said distal end;
whereby excess collected matter on the surface of said distal end outside said indentations are kept out of said vessel by passage of said distal end through said aperture; and
introducing into said vessel a measured volume of specimen-preserving fluid.

21. The method of claim 20, wherein said inserting comprises intimately engaging a washer carrying shoulder formed onto a medial portion of said stick into said passageway.

22. The method of claim 20, which further comprises:
loading said sealed vessel into a sealable bag; and,
placing said bag into a crush resistant mailing box.
